(19) United States
(12) Patent Application Publication
(10) Pub. No.: US 2007/0165940 A1
(43) Pub. Date: Jul. 19, 2007

(54) Semiconductor surface inspection apparatus, surface inspection method, and semiconductor manufacturing apparatus

(76) Inventor: Akio Ishikawa, Tokyo (JP)

Correspondence Address: CHRISTIE, PARKER & HALE, LLP, PO BOX 7068, PASADENA, CA, 91109-7068, US

(21) Appl. No.: 11/652,825

(22) Filed: Jan. 11, 2007

(30) Foreign Application Priority Data
Jan. 13, 2006 (JP) 2006-005757

(51) Int. Cl. G06K 9/00

(52) U.S. Cl. 382/145

(57) ABSTRACT

A semiconductor surface inspection apparatus 20, for detecting a defect existing on a surface of a sample, based on an image captured of the surface of the sample to which prescribed processing is applied in a semiconductor manufacturing apparatus 1, comprises: a defect detection unit 28 which detects a defect in an image captured one of before and after the prescribed processing; and an image extraction unit 32 which extracts, from an image captured the other of after and before the prescribed processing, an image of a portion corresponding to the portion where the defect was detected by the defect detection unit 28.

### CROSS REFERENCE TO RELATED APPLICATION

This application is based upon and claims the benefit of priority from the prior Japanese Patent Application No. 2006-5757, filed on Jan. 13, 2006, the entire contents of which are incorporated herein by reference.

### BACKGROUND OF THE INVENTION

1. Field of the Invention

The present invention relates to a semiconductor surface inspection apparatus and surface inspection method for detecting a defect appearing in a pattern formed on the surface of a sample in a semiconductor manufacturing process based on a captured image of the pattern formed on the surface of the sample, and a semiconductor manufacturing apparatus equipped with such a surface inspection apparatus.

2. Description of the Related Art

In a semiconductor manufacturing process, many chips (dies) are formed on a semiconductor wafer. Patterns are formed in multiple layers on each die. Each completed die is electrically tested using a prober and a tester, and any defective die is removed from the fabrication process.

In the semiconductor manufacturing process, the manufacturing yield is a very important factor, and the result of the electrical testing is fed back to the manufacturing process and used for the management of each process step. However, since the semiconductor manufacturing process consists of many process steps, it takes a very long time before the electrical testing can be conducted after the start of the manufacturing process; as a result, when, for example, a certain process step is found faulty as a result of the electrical testing, many waters are already partway through the process, and the result of the electrical testing cannot be adequately utilized for improving the yield.

To address this, surface inspection is performed by capturing an image of a pattern formed at an intermediate step and checking the pattern for defects based on the thus captured image. If such surface inspection is performed at a plurality of steps in the manufacturing process, it becomes possible to detect any defect that occurred after the previous inspection, and the result of the inspection can thus be promptly reflected in the process management.

FIG. 1 is a schematic diagram showing the configuration of a surface inspection apparatus similar to the one that the applicant of this patent application proposed in Japanese Unexamined Patent Publication No. 2004-177397. As shown, in the surface inspection apparatus 20, a sample holder (chuck stage) 22 is mounted on the upper surface of a stage 21 which is movable in two- or three-dimensional directions. A semiconductor wafer 3 as a sample to be inspected is placed on the sample holder 22 and held fixed thereon. An image capturing unit 24 constructed from a one-dimensional or two-dimensional CCD camera or the like is disposed above the stage, and the image capturing unit 24 generates an image signal by capturing an image of the pattern formed on the semiconductor wafer 3.

As shown in FIG. 2, a plurality of dies 3a are formed on the semiconductor wafer 3 in a matrix pattern repeating in X and Y directions. Since the same pattern is formed on each die, it is general practice to compare the images of corresponding portions between adjacent dies (die-to-die comparison). If there is no defect in the two adjacent dies, the gray level difference between them is smaller than a threshold value, but if there is a defect in either one of the dies, the gray level difference is larger than the threshold value (single detection). At this stage, however, this is no knowing which die contains the defect; therefore, the die is further compared with a die adjacent on a different side and, if the gray level difference in the same portion is larger than the threshold value, then it is determined that the die under inspection contains the defect (double detection).

Further, in a semiconductor memory or the like, repeated patterns of a basic unit called a cell are formed on each die 3a, with one cell pattern as the basic pattern. When inspecting the pattern in which such cells are arranged, the presence or absence of a defect is checked, not by the die-to-die comparison described above, but by comparing the corresponding image data between adjacent cells (cell-to-cell comparison).

The image capturing unit 24 comprises a one-dimensional CCD camera, and the stage 21 is moved so that the camera moves (scans) relative to the semiconductor wafer 3 at a constant speed in the X or Y direction. Image signals are converted into multi-valued digital signals (gray level signals) and stored in an image storage unit 25.

When the gray level signals (inspection image signals) representing the adjacent two dies (in the cell-to-cell comparison, two adjacent cells) are stored in the image storage unit 25, the gray level signals representing small sub-images (called logical frames) taken from the corresponding portions of the two adjacent dies (or cells) are read out of the image storage unit 25 and supplied to a difference detection unit 26. Actually, processing such as fine registration is also performed here, but a detailed description of such processing will not be given here.

The gray level signals representing the sub-images taken from the corresponding portions of the two adjacent dies (or cells) are thus input to the difference detection unit 26. The difference detection unit 26 calculates the difference (gray level difference) between the gray level signals of the respectively corresponding pixels by taking one sub-image as an inspection image and the other as a reference image, and supplies the difference to a detection threshold value calculation unit 27 and a defect detection unit 28. The detection threshold value calculation unit 27 automatically determines the detection threshold value in accordance with the distribution of the gray level difference, and supplies the detection threshold value to the defect detection unit 28. The defect detection unit 28 compares the gray level difference with the thus determined threshold value to judge whether the portion under inspection contains a defect or not. Then, for each portion that has been judged to contain a defect, the defect detection unit 28 outputs defect information which includes such information as the position of the defect, the gray level difference, the detection threshold value used for the detection, the defect detection parameter used to determine the detection threshold value, and the image data of the defective portion containing the defect.

Generally, the noise level of a semiconductor pattern differs depending on the kind of the pattern such as the pattern of a memory cell portion, the pattern of a logic circuit portion, the pattern of a wiring portion, or the pattern of an analog circuit portion. Correspondence between the portion and the kind of the semiconductor pattern can be found from the design data. Therefore, the detection threshold value calculation unit 27 automatically determines the threshold value for each portion, for example, in accordance with the distribution of the gray level difference in that portion, and the defect detection unit 28 performs the above judgment by using the threshold value determined for each portion.

The above surface inspection is performed at a plurality of steps in the semiconductor manufacturing process comprising a large number of steps, but there can occur cases where a defect already existing before a certain process step is not detected in the surface inspection performed before that step (hereinafter referred to as the “previous surface inspection”), but is detected in the surface inspection performed after that step (hereinafter referred to as the “subsequent surface inspection”).

This can occur, for example, when the defect already existing at the time of the previous surface inspection was not detected because a relatively large detection threshold value was used in the previous surface inspection, but was detected in the subsequent surface inspection because a relatively small detection threshold value was used.

Here, and as, in the previous surface inspection, defect information only for the detected defect is generated, it is not possible to know in what condition the portion of the defect detected in the subsequent surface inspection was at the time of the previous surface inspection. There is therefore no knowing whether the defect detected in the subsequent surface inspection was really one that occurred in that step or one that had occurred before that step but went undetected in the previous surface inspection; as a result, it has not been possible to reliably determine whether the fault lies in that step or not.

Furthermore, as the surface inspection is not performed at every process step but is performed once in every plurality of steps by skipping intermediate steps, there has been the problem that, if a defect occurs in a certain step, the defect may be concealed, for example, in a subsequent metal film deposition step before undergoing a surface inspection, resulting in an inability to detect such a defect in the subsequent surface inspection.

### SUMMARY OF THE INVENTION

In view of the above problems, it is an object of the present invention to provide a semiconductor surface inspection apparatus, surface inspection method, and semiconductor manufacturing apparatus that can identify a defect that has newly occurred or disappeared during the processing of a particular step in a semiconductor manufacturing process.

To achieve the above object, a defect is detected in an image captured one of before and after the prescribed processing is applied in the semiconductor manufacturing process, and an image of a portion corresponding to the portion where the defect was detected is extracted from an image captured the other of after and before the prescribed processing.

For example, a defect is detected in the image captured after the processing, and the portion corresponding to the portion where the defect was detected is extracted from the image captured before the processing; then, by observing the extracted image, it can be determined whether the defect has existed in that portion since before the processing was applied.

Alternatively, a defect is detected in the image captured before the processing, and the portion corresponding to the portion where the defect was detected is extracted from the image captured after the processing; then, by observing the extracted image, it can be determined whether the defect is still existing after the processing in the portion where the defect was detected in the image captured before the processing, and hence whether the detected defect is a defect that has disappeared during the processing.

According to a first mode of the present invention, there is provided a semiconductor surface inspection apparatus for detecting a defect existing on a surface of a sample, based on an image captured of the surface of the sample to which prescribed processing is applied in a semiconductor manufacturing process, comprising: a defect detection unit which detects a defect in an image captured one of before and after the prescribed processing; and an image extraction unit for extracting, from an image captured the other of after and before the prescribed processing, an image of a portion corresponding to the portion where the defect was detected by the defect detection unit.

According to a second mode of the present invention, there is provided a semiconductor manufacturing apparatus for manufacturing a semiconductor device by applying prescribed processing to a sample in a semiconductor manufacturing process, comprising: a defect detection unit which detects a defect in an image of the sample captured one of before and after the prescribed processing; and an image extraction unit which extracts, from an image of the sample captured the other of after and before the prescribed processing, an image of a portion corresponding to the portion where the defect was detected by the defect detection unit.

The semiconductor surface inspection apparatus and the semiconductor manufacturing apparatus may each include: an image storage unit which stores the image of the sample captured before the prescribed processing; and an image capturing unit which captures the image of the surface of the sample at least after the prescribed processing.

The image of the sample before the prescribed processing may be acquired by the image capturing unit by capturing the image of the surface of the sample before the prescribed processing, or alternatively, an image captured, for example, by another surface inspection apparatus in a previous step may be acquired and used as the image captured before the prescribed processing.

The semiconductor surface inspection apparatus may be incorporated as part of the semiconductor manufacturing apparatus that manufactures a semiconductor device by applying the prescribed processing to the sample.

In this way, the defect detection unit of the semiconductor surface inspection apparatus incorporated in the semiconductor manufacturing apparatus or the defect detection unit of the semiconductor manufacturing apparatus may be configured to detect a defect in the image captured after the prescribed processing was applied in the semiconductor manufacturing apparatus, and the image extraction unit may be configured to extract, from the image captured before the prescribed processing, the image of the portion corresponding to the portion where the defect was detected by the defect detection unit.

The semiconductor surface inspection apparatus and the semiconductor manufacturing apparatus may further include a defect occurrence determination unit which determines whether the detected defect is a defect that occurred during the processing in the semiconductor manufacturing apparatus, based on whether the image captured before the prescribed processing contains a defect in the portion corresponding to the portion where the defect was detected in the image captured after the prescribed processing.

The semiconductor surface inspection apparatus and the semiconductor manufacturing apparatus may further include a fault detection unit which detects a fault in the semiconductor manufacturing apparatus based on a result of detection of the defect that occurred during the processing in the semiconductor manufacturing apparatus.

The fault detection unit may be configured to detect a fault in the semiconductor manufacturing apparatus based on either the number, kind, distribution, or size of defects that occurred during the processing in the semiconductor manufacturing apparatus, or may be configured to detect a faulty portion in the semiconductor manufacturing apparatus based on either the kind, distribution, or size of such defects.

According to a third mode of the present invention, there is provided a surface inspection method for detecting a defect existing on a surface of a sample, based on an image captured of the surface of the sample to which prescribed processing is applied in a semiconductor manufacturing process, wherein: a defect is detected in an image captured at one of before and after the prescribed processing; and an image of a portion corresponding to the portion where the defect was detected is extracted from a captured image at the other of after and before the prescribed processing.

In the above surface inspection method, defect detection may be performed on the image captured after the prescribed processing, and a determination may be made as to whether the detected defect is a defect that has newly occurred during the prescribed processing, based on whether the image captured before the prescribed processing contains a defect in the portion corresponding to the portion where the detected defect is located.

At this time, a fault in the semiconductor manufacturing apparatus that performs the prescribed processing may be detected based on a result of detection of the defect that has newly occurred during the prescribed processing.

In this case, a fault in the semiconductor manufacturing apparatus may be detected based on either the number, kind, distribution, or size of defects that have newly occurred during the prescribed processing, or alternatively, a faulty portion in the semiconductor manufacturing apparatus may be detected based on either the kind, distribution, or size of defects that have newly occurred.

Further, in the surface inspection method, defect detection may be performed on the image captured before the prescribed processing, and a determination may be made as to whether the detected defect is a defect that has disappeared during the prescribed processing, based on whether the image captured after the prescribed processing contains a defect in the portion corresponding to the portion where the detected defect is located.

### BRIEF DESCRIPTION OF THE DRAWINGS

These and other objects and features of the present invention will become clearer from the following description of the preferred embodiments given with reference to the attached drawings, wherein:

FIG. 1 is a schematic diagram showing the configuration of a semiconductor surface inspection apparatus according to the prior art;

FIG. 2 is a diagram showing an arrangement of dies on a semiconductor wafer;

FIG. 3 is a schematic diagram showing the configuration of a semiconductor manufacturing apparatus according to an embodiment of the present invention;

FIG. 4 is a diagram showing a first configuration example of a semiconductor surface inspection unit shown in FIG. 3; and

FIG. 5 is a diagram showing a second configuration example of the semiconductor surface inspection unit shown in FIG. 3.

### DESCRIPTION OF THE PREFERRED EMBODIMENTS

Preferred embodiments of the present invention will be described in detail below while referring to the attached figures. FIG. 3 is a schematic diagram showing the configuration of a semiconductor manufacturing apparatus according to an embodiment of the present invention.

The semiconductor manufacturing apparatus 1 comprises: a sample processing unit 10 as a conventional semiconductor manufacturing apparatus, such as a lithography apparatus, a CVD apparatus, a PVD apparatus, or a CMP apparatus, which applies prescribed processing to a semiconductor wafer as a sample; a semiconductor surface inspection unit 20 as a semiconductor surface inspection apparatus according to the present invention, which detects a defects on the semiconductor wafer based on an image captured of the surface of the wafer; and a transport unit 40 which transports the wafer to and from the semiconductor manufacturing apparatus 1 as well as within the apparatus 1.

A plurality of semiconductor wafers (for example, 25 wafers) are accommodated in a wafer cassette 50 and loaded into the semiconductor manufacturing apparatus 1. When the wafer cassette 50 is loaded into the transport unit 40 of the semiconductor manufacturing apparatus 1, a first wafer arm 41 of the transport unit 40 removes one wafer at a time from the cassette 50 and transports it along a pass 91 to the semiconductor surface inspection unit 20.

When the semiconductor wafer is transported to the semiconductor surface inspection unit 20, an image is captured of the wafer surface in the semiconductor surface inspection unit 20 before the processing is applied by the sample processing unit 10. After that, the semiconductor wafer is transported along a pass 92 to the sample processing unit 10 by a second wafer arm 42 of the transport unit 40, and prescribed processing, such as lithography, CVD, PVD, or CMP, according to the kind of the semiconductor manufacturing apparatus 1, is applied to the semiconductor wafer.

After the prescribed processing is applied, the semiconductor wafer is transported by the first water arm 41 back to the semiconductor surface inspection unit 20 along a pass 93.

In the semiconductor surface inspection unit 20, an image is captured of the wafer surface thus processed by the sample processing unit 10. After capturing the image, the semiconductor surface inspection unit 20 performs processing to detect a defect in the image captured after the processing was applied by the sample processing unit 10 (the image will hereinafter be referred to as the “image captured after the processing”). Next, an image of a portion corresponding to the portion where the defect was detected in the image captured after the processing is extracted from the image captured before the processing was applied by the sample processing unit 10 (the image will hereinafter be referred to as the “image captured before the processing”). Then, based on the thus extracted image, it is determined whether the detected defect is a defect that has newly occurred during the processing in the sample processing unit 10. The configuration of the semiconductor surface inspection unit 20 will be described in detail later.

The wafer inspected by the semiconductor surface inspection unit 20 is transported along the pass 93 by the first wafer arm 41 and returned to the wafer cassette 50.

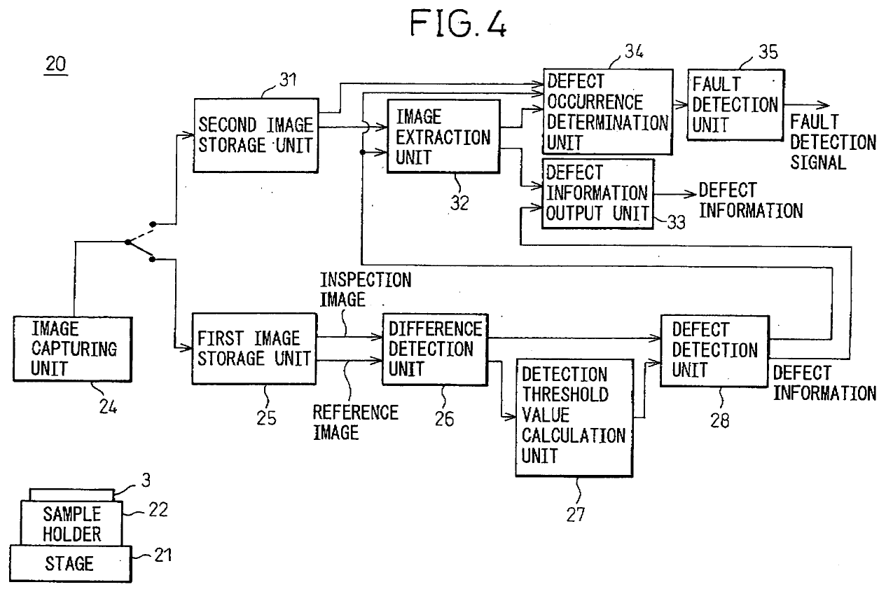

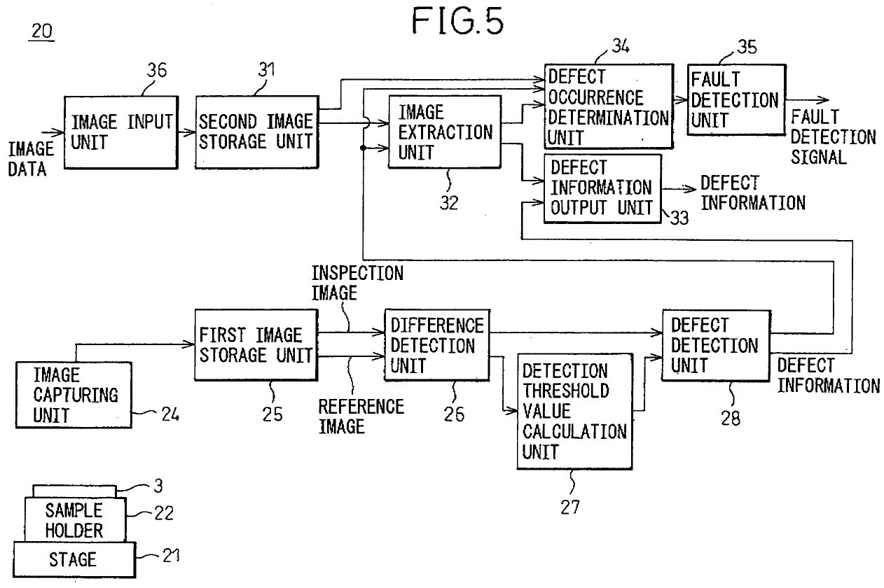

FIG. 4 is a diagram showing a first configuration example of the semiconductor surface inspection unit 20 shown in FIG. 3. As shown in FIG. 4, the semiconductor surface inspection unit 20 comprises: a stage 21 which is movable in two- or three-dimensional directions; a sample holder (chuck stage) 22 mounted on the upper surface of the stage 21; an image capturing unit 24 constructed from a one-dimensional or two-dimensional CCD camera or the like disposed above the stage; a first image storage unit 25 which stores the image captured by the image capturing unit 24 after the processing; a difference detection unit 26 which computes a difference signal (gray level difference signal) by comparing images of corresponding portions between two adjacent dice (in the cell-to-cell comparison, two adjacent cells) in the image stored in the first image storage unit 25; a detection threshold value calculation unit 27 which automatically determines the detection threshold value in accordance with the distribution of the gray level difference signal computed by the difference detection unit 26; and a defect detection unit 28 which determines the presence or absence of a defect by comparing the gray level difference with the threshold value.

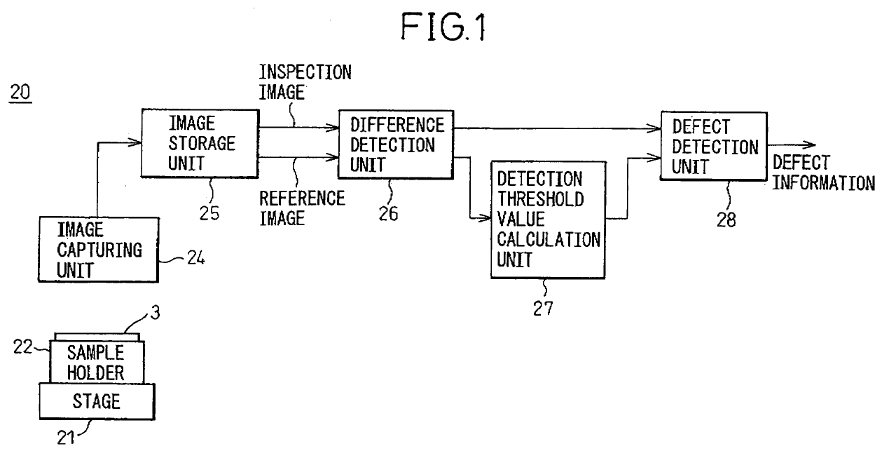

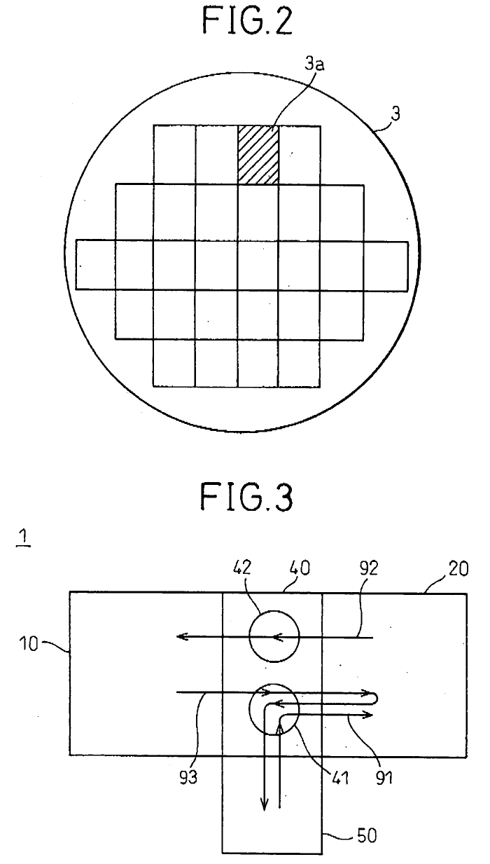

The functions of the component elements 25 to 28 are the same as those of the corresponding component elements 25 to 28 in the prior art surface inspection apparatus described with reference to FIG. 1, and therefore, will not be described in detail here.

Defect detection can also be performed by storing images of a plurality of wafers 3 in the first image storage unit 25 and by comparing the wafer images. In this case, the difference detection unit 26 compares the image of a portion of one wafer image with the image of a corresponding portion of another wafer image, and computes the gray level difference signal representing their difference, and the defect detection unit 28 compares the gray level difference with the threshold value to determine whether the portion under inspection contains a defect or not.

The semiconductor surface inspection unit 20 further comprises a second image storage unit 31, an image extraction unit 32, and a defect information output unit 33.

The second image storage unit 31 stores the image captured before the processing, which was acquired by capturing an image of the surface of the semiconductor wafer 3 that was removed from the wafer cassette 50 and transported to the semiconductor surface inspection unit 20 by the first wafer arm 41 before the processing in the sample processing unit 10.

The image extraction unit 32 takes as an input the defect information concerning the defect that the defect detection unit 28 detected as described above in the image captured after the processing. Then, the sub-image representing the defective portion indicated by the defect information is extracted from the image captured and stored in the second image storage unit 31 before the processing.

The defect information output unit 33 outputs the sub-image that the image extraction unit 32 extracted for the detected defect, together with the defect information concerning the defect detected by the defect detection unit 28. For example, the defect information output unit 33 outputs the sub-image extracted by the image extraction unit 32 to a display device such as a CRT for display, to a printer for printing, or to an external computer device such as an automatic defect classifying device, a yield management device, or a host device.

By viewing the extracted image thus displayed or printed, the operator can determine whether the defect is a defect that has occurred during the processing in the semiconductor manufacturing apparatus 1 or a defect that has existed since before the processing.

Further, by outputting the extracted image to the automatic defect classifying device or the yield management device, the defect detection can be done in such devices based on the extracted image, and a determination can be made as to whether the defect is a defect that has occurred during the processing in the semiconductor manufacturing apparatus 1 or a defect that has been existent since before the processing.

Here, the determination as to whether the defect is a defect that has occurred during the processing in the semiconductor manufacturing apparatus 1 may be made in the semiconductor surface inspection unit 20 itself. For this purpose, the semiconductor surface inspection unit 20 includes a defect occurrence determination unit 34 which checks the image captured before the processing to see if it also shows a defect at the position of the defect detected by the defect detection unit 28 and, based on the presence or absence of the defect, determines whether the defect is a defect that has occurred during the processing in the semiconductor manufacturing apparatus 1.

The defect occurrence determination unit 34 may be configured to determine the presence or absence of the defect in the following manner. For example, the defect detection unit 28 outputs the defect information by including therein the sub-image of the portion where the defect was detected after the processing, and the defect occurrence determination unit 34 detects the difference between the sub-image representing the range extracted by the image extraction unit 32 and the sub-image included in the defect information and, if the difference is small, then determines that the defect has been there since before the processing was applied in the semiconductor manufacturing apparatus 1; on the other hand, if the difference is large, it is determined that the detected defect is not a defect that has been there since before the processing was applied in the semiconductor manufacturing apparatus 1.

Alternatively, the defect occurrence determination unit 34 may be configured to determine the presence or absence of the defect in the range extracted by the image extraction unit 32, by performing on the image captured before the processing and stored in the second image storage unit 31 the same processing as the image comparison processing performed by the difference detection unit 26, the detection threshold value calculation unit 27, and the defect detection unit 28.

In that case, the defect occurrence determination unit 34 may be configured to compare the image of the portion containing the detected position of the defect indicated by the defect information and its surrounding area with the reference image of the corresponding portion (for example, between the corresponding portions of adjacent dice in the die-to-die comparison, and between the corresponding portions of adjacent cells in the cell-to-cell comparison).

The semiconductor surface inspection unit 20 may further include a fault detection unit 35 which detects a fault in the semiconductor manufacturing apparatus 1 based on the result of the detection of the defect that has been judged to have occurred during the processing in the semiconductor manufacturing apparatus 1. The fault detection unit 35 can detect a fault in the semiconductor manufacturing apparatus 1 based on either the number of such defects or the kind, distribution, or size of the defects.

For example, when the number of detected defects is larger than a predetermined value, it may be determined that the fault lies in the semiconductor manufacturing apparatus 1, thus detecting a fault in the semiconductor manufacturing apparatus 1. Alternatively, it may be determined that a fault is detected in the semiconductor manufacturing apparatus 1 when a defect has occurred that is larger than a predetermined area.

When a defect-causing material or the like can be deduced, for example, from the kind, size, or shape of the defect, the portion where the defect-causing material is used can be identified as being a faulty portion. It is also possible to locate a faulty portion, such as a portion affected by an accumulation of dirt, for example, in a gas outlet, based on the position where defects concentrate or the degree of concentration or the distribution thereof.

When a fault is detected in the semiconductor manufacturing apparatus 1, the fault detection unit 35 outputs a fault detection signal indicating the detection and the position of the fault. The fault detection signal may be displayed on a display device and used as a warning signal urging an operator to perform maintenance of the semiconductor manufacturing apparatus 1, or may be used as a self-diagnostic signal in the semiconductor manufacturing apparatus 1 for causing the maintenance of the semiconductor manufacturing apparatus 1 (for example, automatic cleaning of the specified portion within the apparatus) to start in response to the fault detection signal.

The difference detection unit 26, the detection threshold value calculation unit 27, the defect detection unit 28, the image extraction unit 32, the defect information output unit 33, the defect occurrence determination unit 34, and the fault detection unit 35 may be implemented in hardware circuits configured to implement the respective functions, or in software modules to be executed by a single or a plurality of information processing apparatuses (computers, etc.) to implement the respective functions.

In FIG. 4, the first image storage unit 25 and the second image storage unit 31 are shown as separate component elements, but these may units be implemented in different storage areas within the same storage device.

In the foregoing, it has been described that the image captured after the processing is stored in the first image storage unit 25, while the image captured before the processing is stored in the second image storage unit 31, and that defect detection is performed on the image captured after the processing and the image of the portion corresponding to the portion where the defect was detected in the image captured after the processing is extracted from the image captured before the processing.

Alternatively, the image captured before the processing may be stored in the first image storage unit 25, and the image captured after the processing may be stored in the second image storage unit 31. In that case, the difference detection unit 26, the detection threshold value calculation unit 27, and the defect detection unit 28 perform defect detection on the image captured before the processing, and the image of the portion corresponding to the portion where the defect was detected by the defect detection unit 28 is extracted from the image captured and stored in the second image storage unit 31 after the processing. Then, the defect information output unit 33 outputs the thus extracted image together with the defect information concerning that defect.

By determining the presence or absence of the defect in the extracted image in this way, it becomes possible to detect any defect that has disappeared during the processing in the semiconductor manufacturing apparatus 1. Such detection process may be performed in the defect occurrence determination unit 34.

The semiconductor surface inspection unit 20 is included in the semiconductor manufacturing apparatus 1 as described above; the benefit of this is that the is images captured before the processing in the semiconductor manufacturing apparatus 1 can be held in memory with a relatively small capacity until after the processing. That is, when the semiconductor surface inspection unit 20 is provided as a separate apparatus from the semiconductor manufacturing apparatus 1, it becomes necessary to provide a storage capacity equivalent to the number of wafers (usually, 25 wafers) that can be accommodated in the wafer cassette 50 and in units of which the semiconductor wafers 3 are handled, but when the semiconductor surface inspection unit 20 is incorporated in the semiconductor manufacturing apparatus 1 as described above, the number of captured images to be stored is at most three, one for the wafer currently under processing, one for the wafer held in the transport unit 40, and one for the wafer currently under surface inspection.

However, if a large number of captured images of wafers can be handled using a large-capacity storage unit or storage medium, the semiconductor surface inspection unit 20 may be provided as a separate apparatus from the semiconductor manufacturing apparatus 1, and when it is provided as a separate apparatus, the image after the processing may be captured using its own image capturing unit 24, and the image captured, for example, by another surface inspection apparatus in a pervious step may be acquired and used as the image captured before the processing.

FIG. 5 shows a second configuration example of the thus configured semiconductor surface inspection unit 20.

The semiconductor surface inspection unit 20 includes an image input unit 36 via which the image captured before the processing is input, and the image captured before the processing and input via the image input unit 36 is stored in the second image storage unit 31. The image input unit 36 may be implemented using a drive unit that can read a storage medium (such as a DVD disk, a Blu-ray disk, or a flash memory) on which the image captured by another surface inspection apparatus in a previous step is stored, or using a network adapter for receiving such captured images via a network.

The image capturing unit 24 here is used to capture the image after the prescribed processing was applied in the semiconductor manufacturing apparatus 1, and the image captured after the processing is stored in the first image storage unit 25.

The other component elements are the same as those in the first configuration example of the semiconductor surface inspection unit 20 shown in FIG. 4, and the description of such component elements will not be repeated here.

According to the present invention, it becomes possible to determine whether a defect detected after a given step in the semiconductor manufacturing process is one that occurred after the inspection performed in that step, and the faulty step can thus be identified with good accuracy. Furthermore, according to the present invention, it becomes possible to capture a defect that has disappeared during a given step in the semiconductor manufacturing process.

By incorporating the above semiconductor surface inspection apparatus as part of the semiconductor manufacturing apparatus that manufactures semiconductor devices by applying prescribed processing to samples, the amount of data necessary to store the captured images can be reduced. That is, if the image corresponding to the defective portion detected one of before and after the prescribed processing is to be extracted from the image captured the other of after and before that processing, the image captured before the processing must be held in memory at least during that processing.

However, since the samples such as semiconductor wafers are usually handled by accommodating a plurality of samples (usually, 25 samples) in one cassette, if the semiconductor surface inspection apparatus is provided as a separate apparatus from the semiconductor manufacturing apparatus, the apparatus must be configured so as to be able to store the captured images for all the samples accommodated in one cassette; otherwise, one would find it inconvenient to handle the wafers.

As the captured images used in the surface inspection apparatus are very high resolution, the amount of data for each captured image is extremely large, and it is not realistic to use a storage medium that can store the captured images for all the samples accommodated in the cassette.

When the semiconductor surface inspection apparatus is incorporated as part of the semiconductor manufacturing apparatus as earlier described, the amount of data to be stored can be greatly reduced, because it is sufficient to store as many images as there are samples currently being processed in the semiconductor manufacturing apparatus.

Further, in the prior art, it has not been possible to determine whether a defect detected in a given step is really one that occurred in that step, and therefore, it has been difficult to automatically determine, based on the detected defect, the presence or absence of fault or the position of the fault in the semiconductor manufacturing apparatus responsible for that step; on the other hand, according to the present invention, as it can be accurately determined whether that step is faulty or not, the presence or absence of fault and the position of the fault in the semiconductor manufacturing apparatus responsible for that step can be accurately determined automatically based on the number of detected defects or the kind, distribution, or size of the defects.

The present invention is applicable to a semiconductor surface inspection apparatus and surface inspection method for detecting a defect appearing in a pattern formed on the surface of a sample in a is semiconductor manufacturing process based on an image captured of the pattern formed on the surface of the sample, and a semiconductor manufacturing apparatus equipped with such a surface inspection apparatus.

While the invention has been described with reference to specific embodiments chosen for purpose of illustration, it should be apparent that numerous modifications could be made thereto, by those skilled in the art, without departing from the basic concept and scope of the invention.

1. A semiconductor surface inspection apparatus for detecting a defect existing on a surface of a sample, based on an image captured of the surface of said sample to which prescribed processing is applied in a semiconductor manufacturing process, comprising:
a defect detection unit which detects a defect in an image captured one of before and after said prescribed processing; and
an image extraction unit which extracts, from an image captured the other of after and before said prescribed processing, an image of a portion corresponding to the portion where said defect was detected by said defect detection unit.

2. A semiconductor surface inspection apparatus as claimed in claim 1, further comprising:
an image storage unit which stores the image of said sample captured before said prescribed processing; and
an image capturing unit which captures the image of the surface of said sample at least after said prescribed processing.

3. A semiconductor surface inspection apparatus as claimed in claim 2, wherein said image capturing unit captures the image of the surface of said sample before said prescribed processing as well as after said prescribed processing, and
said image storage unit stores the image of said sample that said image capturing unit captured before said prescribed processing.

4. A semiconductor surface inspection apparatus as claimed in claim 1, wherein said semiconductor surface inspection apparatus is incorporated in a semiconductor manufacturing apparatus which manufactures a semiconductor device by applying said prescribed processing to said sample.

5. A semiconductor surface inspection apparatus as claimed in claim 4, wherein said defect detection unit detects a defect in the image captured after said prescribed processing.

6. A semiconductor surface inspection apparatus as claimed in claim 5, further comprising a defect occurrence determination unit which determines whether said detected defect is a defect that occurred during said processing in said semiconductor manufacturing apparatus, based on whether the image captured before said prescribed processing contains a defect in the portion corresponding to the portion where said detected defect is located.

7. A semiconductor surface inspection apparatus as claimed in claim 6, further comprising a fault detection unit which detects a fault in said semiconductor manufacturing apparatus based on a result of detection of the defect that occurred during said processing in said semiconductor manufacturing apparatus.

8. A semiconductor surface inspection apparatus as claimed in claim 7, wherein said fault detection unit detects a fault in said semiconductor manufacturing apparatus based on either the number, kind, distribution, or size of detects that occurred during said processing in said semiconductor manufacturing apparatus.

9. A semiconductor surface inspection apparatus as claimed in claim 7, wherein said fault detection unit detects a faulty portion in said semiconductor manufacturing apparatus based on either the kind, distribution or size of defects that occurred during said processing in said semiconductor manufacturing apparatus.

10. A semiconductor manufacturing apparatus for manufacturing a semiconductor device by applying prescribed processing to a sample in a semiconductor manufacturing process, comprising:
a defect detection unit which detects a defect in an image of said sample captured one of before and after said prescribed processing; and
an image extraction unit which extracts, from an image of said sample captured the other of after and before said prescribed processing, an image of a portion corresponding to the portion where said defect was detected by said defect detection unit.

11. A semiconductor manufacturing apparatus as claimed in claim 10, further comprising:
an image storage unit which stores the image of said sample captured before said prescribed processing; and
an image capturing unit which captures the image of a surface of said sample at least after said prescribed processing.

12. A semiconductor manufacturing apparatus as claimed in claim 11, wherein said image capturing unit captures the image of the surface of said sample before said prescribed processing as well as after said prescribed processing, and
said image storage unit stores the image of said sample that said image capturing unit captured before said prescribed processing.

13. A semiconductor manufacturing apparatus as claimed in claim 10, wherein said defect detection unit detects a defect in the image captured after said prescribed processing.

14. A semiconductor manufacturing apparatus as claimed in claim 13, further comprising a defect occurrence determination unit which determines whether said detected defect is a defect that occurred during said prescribed processing, based on whether the image captured before said prescribed processing contains a defect in the portion corresponding to the portion where said detected defect is located.

15. A semiconductor manufacturing apparatus as claimed in claim 14, further comprising a fault detection unit which detects a fault in said semiconductor manufacturing apparatus based on a result of detection of the defect that occurred during said prescribed processing.

16. A semiconductor manufacturing apparatus as claimed in claim 15, wherein said fault detection unit detects a fault in said semiconductor manufacturing apparatus based on either the number, kind, distribution, or size of defects that occurred during said prescribed processing.

17. A semiconductor manufacturing apparatus as claimed in claim 15, wherein said fault detection unit detects a faulty portion in said semiconductor manufacturing apparatus based on either the kind, distribution or size of defects that occurred during said prescribed processing.

18. A surface inspection method for detecting a defect existing on a surface of a sample, based on an image captured of the surface of said sample to which prescribed processing is applied in a semiconductor manufacturing process, wherein:
a defect is detected in an image captured one of before and after said prescribed processing; and
an image of a portion corresponding to the portion where said defect was detected is extracted from an image captured the other of after and before said prescribed processing.

19. A surface inspection method as claimed in claim 18, wherein a defect is detected in the image captured after said prescribed processing, and
a determination is made as to whether said detected defect is a defect that has newly occurred during said prescribed processing, based on whether the image captured before said prescribed processing contains a defect in the portion corresponding to the portion where said detected defect is located.

20. A surface inspection method as claimed in claim 19, wherein a fault in a semiconductor manufacturing apparatus that performs said prescribed processing is detected based on a result of detection of the defect that has newly occurred during said prescribed processing.

21. A surface inspection method as claimed in claim 20, wherein a fault in said semiconductor manufacturing apparatus is detected based on either the number, kind, distribution, or size of defects that have newly occurred during said prescribed processing.

22. A surface inspection method as claimed in claim 20, wherein a faulty portion in said semiconductor manufacturing apparatus is detected based on either the kind, distribution, or size of defects that have newly occurred during said prescribed processing.

23. A surface inspection method as claimed in claim 18, wherein a defect is detected in the image captured before said prescribed processing, and
a determination is made as to whether said detected defect is a defect that has disappeared during said prescribed processing, based on whether the image captured after said prescribed processing contains a defect in the portion corresponding to the portion where said detected defect is located.
